(19) United States
(12) Patent Application Publication
(10) Pub. No.: US 2013/0060595 A1
(43) Pub. Date: Mar. 7, 2013

(54) INVENTORY MANAGEMENT AND BUDGETING SYSTEM

(71) Applicant: Stephen Bailey, Carbondale, IL (US)

(72) Inventor: Stephen Bailey, Carbondale, IL (US)

(21) Appl. No.: 13/224,099

(22) Filed: Sep. 1, 2011

(51) Int. Cl. G06Q 10/00

(52) U.S. Cl. 705/7.24

(57) ABSTRACT

Systems and methods for forecasting a buying budget for a future inventory and selling period includes receiving historical revenue and historical inventory data associated with a particular category of products. Selling seasons are defined from the historical revenue and historical inventory data. For each selling season, a buying budget may be determined indicating how much a retailer should spend purchasing inventory for the season. A user interface may be used to modify various inputs that may impact the buying budget for a given season, such as modifying the definition of a seasonal period and modifying monthly revenue goals.

### FIELD

The present document relates generally to inventory management, and more specifically to systems and methods for forecasting future inventory demands and inventory buying budgets.

### BACKGROUND

In many business environments, such as the consumer retail industry, proper inventory management is crucial to ensuring the success of a retail business and maximization of business profitability. Improper inventory management can cause many businesses to exhaust inventories for important products, thereby failing to meet demand, and result in a loss of sales. Additionally, improper inventory management can also cause many businesses to expend unnecessary capital accumulating excess inventory for products that are under consumed, sold, or used, whereas such capital could have been used for other types of investment.

In an attempt to ensure that proper inventory levels are maintained for a category, department, and/or particular product within a business at any given time, many businesses analyze historical inventory data for the particular product to forecast future demand. Various techniques have been used to analyze historical inventory data, such as identifying buyer trends, identifying changes in supply pricing, and linear modeling. However, many of these techniques can be inaccurate, as they do not consider important factors, such as seasonal effects and/or other casual factors understood by the business, all of which affect inventory levels and buying budgets. Thus, there is a need for accurate and dynamic methods and systems that provide inventory management and calculate buying budgets for a business.

### SUMMARY

The present disclosure provides systems and methods for managing product inventories and calculating a buying budget. In one aspect, a system for calculating a buying budget includes a processor and a memory in operable communication with the processor. The system includes a seasonal buying budget application comprising modules executable by the processor. The modules include a GUI module to generate a graphical user interface for display comprising at least one seasonal period and the modification tool to modify the at least one seasonal period to create the at least one modified seasonal period and receive a modification input via a modification tool, the modification redefining the at least one seasonal period based on one or more customization criteria. The modules include a receiving module to receive a selection of a future inventory budgeting period, receive historical revenue data and historical inventory data, receive corresponding historical inventory data for at least one modified season, and receive a revenue goal percentage for the at least one modified season. The modules include a season generation module to determine a seasonal period based on the historical revenue data and the historical inventory data for the future inventory budgeting period. The modules also include a buying budget module to determine a buying budget for the at least one modified seasonal period based on the corresponding historical inventory data and the revenue goal percentage.

In another aspect, a method for inventory management and budgeting is provided. The method includes receiving, at a processor, a selection of a future inventory budgeting period. The method includes receiving, at the processor, historical revenue data and historical inventory data. The method includes determining, at the processor, at least one seasonal period based on the historical revenue data and the historical inventory data for the future inventory budgeting period. The method also includes generating, at the processor, a graphical user interface for display comprising the at least one seasonal period and a modification tool to modify the at least one seasonal period. The method includes receiving, at the processor, a modification input via the modification tool, the modification input redefining the at least one seasonal period to create at least one modified seasonal period based on one or more customization criteria. The method includes receiving, at the processor, corresponding historical inventory data for the at least one modified seasonal period and receiving, at the processor, a revenue goal percentage for the at least one modified seasonal period. The method further includes determining, at the processor, a buying budget for the at least one modified seasonal period based on the corresponding historical inventory data and the revenue goal percentage.

In yet another aspect, a computer-readable medium encoded with a seasonal buying budget application comprising modules executable by a processor is provided. The modules include a GIU module to generate a graphical user interface for display comprising at least one seasonal period and the modification tool to modify the at least one seasonal period to create the at least one modified seasonal period and receive a modification input via a modification tool, the modification redefining the at least one seasonal period based on one or more customization criteria. The modules include a receiving module to receive a selection of a future inventory budgeting period, receive historical revenue data and historical inventory data, receive corresponding historical inventory data for at least one modified season, and receive a revenue goal percentage for the at least one modified season. The modules include a season generation module to determine a seasonal period based on the historical revenue data and the historical inventory data for the future inventory budgeting period. The modules also include a buying budget module to determine a buying budget for the at least one modified seasonal period based on the corresponding historical inventory data and the revenue goal percentage.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE FIGURES

Aspects of the present disclosure will describe exemplary embodiments, but not limitations, illustrated by the accompanying drawings wherein like references indicate similar elements, and wherein:

FIG. 1 depicts an operating environment for implementing aspects of an inventory management and budgeting system;

FIG. 2 is a block diagram depicting one embodiment of the inventory management and budgeting system;

FIG. 3 depicts a workflow of an embodiment of the inventory management and budgeting system; and

FIG. 4 is a flow chart illustrating one method for implementing the inventory management and budgeting system;

FIG. 5 is an illustrative example of a display generated by the inventory management and budgeting system;

FIG. 6 is a chart illustrating an example monthly revenues over a particular time period;

FIG. 7 is another chart illustrating an example of monthly inventory over a particular time period; and

FIG. 8 is a chart illustrating an example of purchases by season over a particular time period.

### DETAILED DESCRIPTION

Typically, retail businesses may be divided into a large number of different categories or departments with each department and/or category representing a different product or different type of merchandise. Additionally, each retail business may be divided into seasonal periods for purposes of inventory management and budgeting. For example, a seasonal period or selling season in a retail business, is a limited period of time in which a business or retailer intends to sell a particular product inventory. Seasonal periods may be defined on a per month basis for a yearly calendar (each month representing a season); on a seasonal calendar basis (i.e. winter, spring, summer, or fall); on a fiscal calendar basis; on a quarterly calendar basis; any user-defined per-determined period of time; etc. In addition, each of the different products and/or merchandise sold by the business may be associated with a particular seasonal period. For example, a gardening business may have two categories of products: lawn care products and plant products. The gardening business may define the seasonal periods in which the business may sell lawn care products and plant products based on the winter, spring, summer, and fall seasons of a particular calendar year. In particular, a gardening business may purchase winter-related lawn care and plant product inventories during the winter season, spring-related lawn care and plant product inventories during the spring season, summer-related lawn care and plant product inventories during the summer season, and fall-related lawn care and plant product inventories during the fall season.

Retail businesses purchase the products and/or merchandise during a particular seasonal period with the intent to sell off most, if not all, of the inventory. Referring back to the gardening example, the gardening business may purchase $10,000 at cost in sprinkler system-related lawn care products during the summer seasonal period with the intent to sell all $10,000 at cost sprinkler system-related lawn care products during that summer seasonal period. However, if the entire purchased inventory does not sell (i.e. all of the $10,000 at cost worth of sprinkler systems) the result is a buildup of unused product inventory. Alternatively, if the gardening business does not purchase enough at cost sprinkler system-related lawn care products in dollar value to meet customer demand during a particular seasonal period, the retail business can suffer lost revenues. Additionally, if the gardening business sold sprinkler system-related lawn care products valued $10,000 at cost in inventory during the summer seasonal period before the summer seasonal period ends, such a garden business would lose any additional potential sales during that seasonal period from customers demanding additional sprinklers.

Moreover, when excess inventory exists, there is a lack of urgency by retailers to liquidate excess inventory and subsequently purchase additional seasonal inventory that potential and/or current customers may be interested in purchasing. Such actions can result in cash flow margin reduction issues, and product obsolescence and degradation for a business, which if left unmanaged, may cause the business to risk financial collapse.

Various aspects of the present disclosure extend to methods, systems, and computer program products for forecasting product inventory levels and seasonal buying budgets for a retail business. In particular, aspects of the present disclosure include estimating a buying budget for a category of inventory based on forecasted sales of a category, department, and/or particular product during a particular season at an anticipated Margin/Cost of Goods Sold level, while considering confounding factors, such as current inventory levels for the category of inventory and changing revenue goals forecasted for future months. Although methods and systems are described herein in connection with a business retailer related to gardening products, it is contemplated that the principles and aspects described herein may be applied to any other type of business with similar transactions and parties, such as motor vehicle and parts dealers, recreational vehicle dealers, furniture stores, electronics and appliances stores, food and beverage stores, healthcare stores, clothing stores, as well as other retail businesses that sell products during seasonal buying periods.

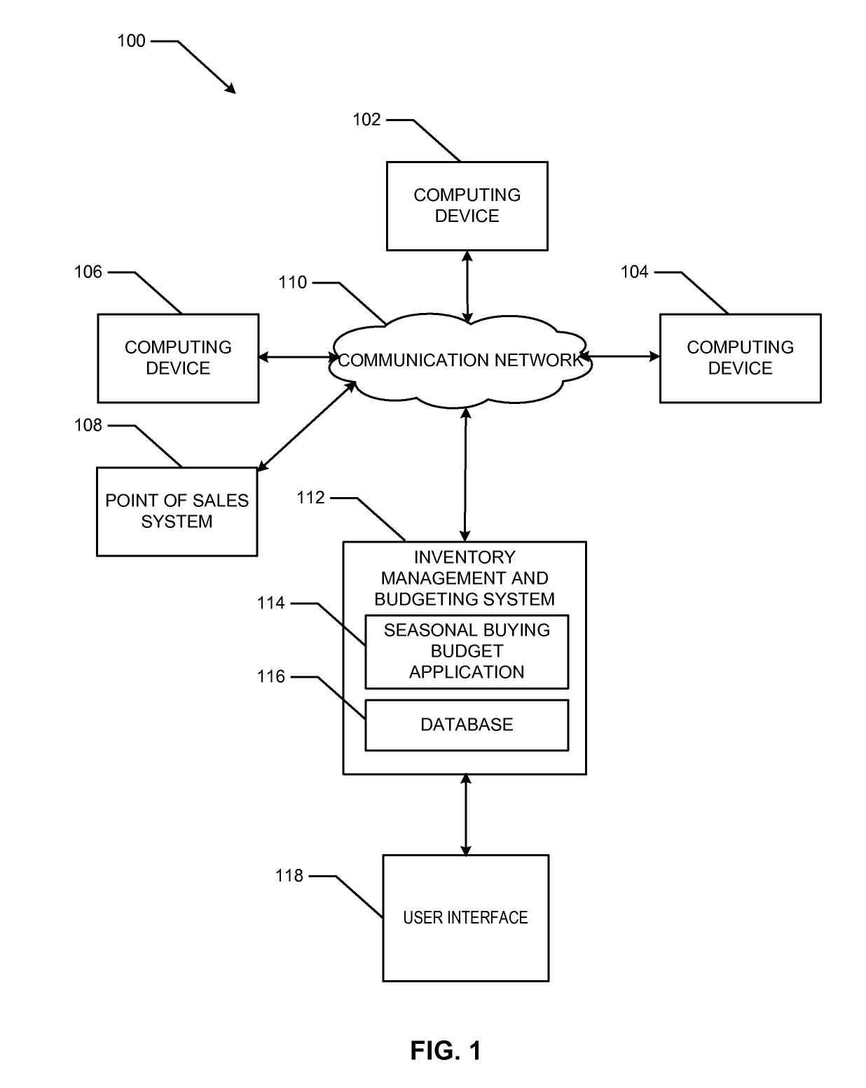

FIG. 1 illustrates an operating environment 100 for performing aspects of the inventory management and budgeting system 112 as disclosed herein according to one embodiment. The operating environment 100 includes a plurality of computing devices 102-106, a point of sales system 108, a communication network 110, an inventory management and budgeting system 112, and a user interface 118.

Computing devices 102-106 may be computing devices with a wide variety of processing, communication and memory capabilities. According to one aspect, computing devices 102-106 may be a computer, a processing device, a communication device, or the like, such as a personal computer, a server computer, a tablet computer, a mobile processing device, and/or a mobile communication device. Each computing device 102-106 may include one or more processors that process software and/or machine readable instructions and include a memory to store the software or other machine readable instructions and data. The memory may include volatile and/or non-volatile memory. Each computing device 102-106 may also include a communication system to communicate via a wireline and/or wireless communications, such as through the Internet, an intranet, an Ethernet network, a wireline network, a wireless network, and/or other communication network. Each computing device 102-106 may further include a display (not shown) for viewing data, such as a computer monitor, and an input device (not shown), such as a keyboard or a pointing device (e.g., a mouse, trackball, pen, touch pad, or other user interface device) for entering data and navigating through data, including exams, images, documents, structured data, unstructured data, HTML pages, other web pages, and other data.

In one embodiment, each computing device 102-106 communicates with the inventory management and budgeting system 112 via the communication network 110. The communication network 110 can be the Internet, an intranet, a local area network, a wireless local network, or another communication network, as well as combinations of networks. In another embodiment, the computing devices 102-106 may be coupled or communicatively connected to the inventory management and budgeting system 112 from a remote location, such as by a wide area network or via the Internet. For example the computing devices 102-106 may communicate with the inventory management and budgeting system 112 through a private network for seasonal buying budgeting and inventory management. Various levels of access to the computing environment 100 may be provided through a password and user ID system. In another aspect, the computing devices 102-106 may communicate with the inventory management and budgeting system 112 directly such as through an Ethernet connection.

According to one aspect, each computing device 102-106 is associated with a business retailer. A business retailer is a person, party, business, or group engaged in the sale of products, goods, services, and/or merchandise. The business retailer uses an output device such as a keyboard, mouse, touch screen, associated with the computing devices 102-106 (not shown), to enter seasonal period data. Seasonal period data includes any data relating to the inventory management, sales, costs, or revenues associated with a particular category or product during a season. For example, seasonal period data may include revenue data, historical revenue data, inventory data, historical inventory data, and historical purchases data. Revenue data refers to any data relating to income that a business, such as a retailer, receives from normal business activities, usually from the sale of goods and/or services to customers. For example, revenues may include any income, interest, dividends, and/or royalties from the sale of products. Historical revenue data refers to revenue data received during a period of time that has passed. For example, revenue data received during last year's fiscal calendar. Inventory data refers to any data related to inventory for a particular product and/or category. For example, referring to the gardening example, inventory data may include data indicating the inventory levels for sprinklers are 200,000 units during the summer seasonal period. Historical inventory data refers to inventory data received during a predetermined period of time that has already passed, such as last calendar year or last month. Historical purchases data refers to purchases made during a pre-determined period of time that has passed, such as a past month or season.

A user associated with the retailer business uses computing devices 102-106 to generate a historical revenue and/or historical inventory data entry request to transmit to the inventory management and budgeting system 112. The inventory management and budgeting system 112 transmits a historical inventory data, historical purchases data, and/or historical revenue data input form to display at computing devices 102-106 in response to the user request. After entering the historical revenue data and/or historical inventory data for the predetermined period of time, the business retailer uses the input device to input and transmit the historical revenue data and the historical inventory data to the inventory management and budgeting system 112.

The point of sales system 108 may be a computerized system incorporating registers, computers and peripheral equipment, usually on a computer network. According to one aspect, the point of sales system 108 may keep track of sales, and can generate records used in accounting and book keeping. According to another aspect, the point of sales system 108 may generate revenues, purchases, and inventory data. For example, the point of sales system 108 may keep track of historical revenue data and/or historical inventory data for a retailer or retail business. The point of sales system 108 may also transmit historical revenue data and historical inventory data to the inventory management and budgeting system 112. According to another aspect, the point of sales system 108 may work in the same way as the computing devices 102-106 when transmitting historical revenue data and/or historical inventory data to the inventory management and budgeting 112, such as over communication network 110.

In some embodiments, a user-interface (UI) 118 may be operatively coupled to the inventory management and budgeting system 112 such that a business retailer, or other user, may input historical revenue, purchases, and inventory data to perform inventory management and calculate a buying budget. The UI 118 may include a display (not shown), such as a computer monitor for viewing data and/or input forms, and the input device for entering data.

According to another aspect, the historical revenue data and historical inventory data may be received and/or retrieved from another processing device such as a computer, server, mobile device, and/or any other type of processing device. In yet another aspect, the historical revenue data and historical inventory data may be retrieved (i.e. downloaded) from a database 116 used to perform inventory management and seasonal buying budgeting.

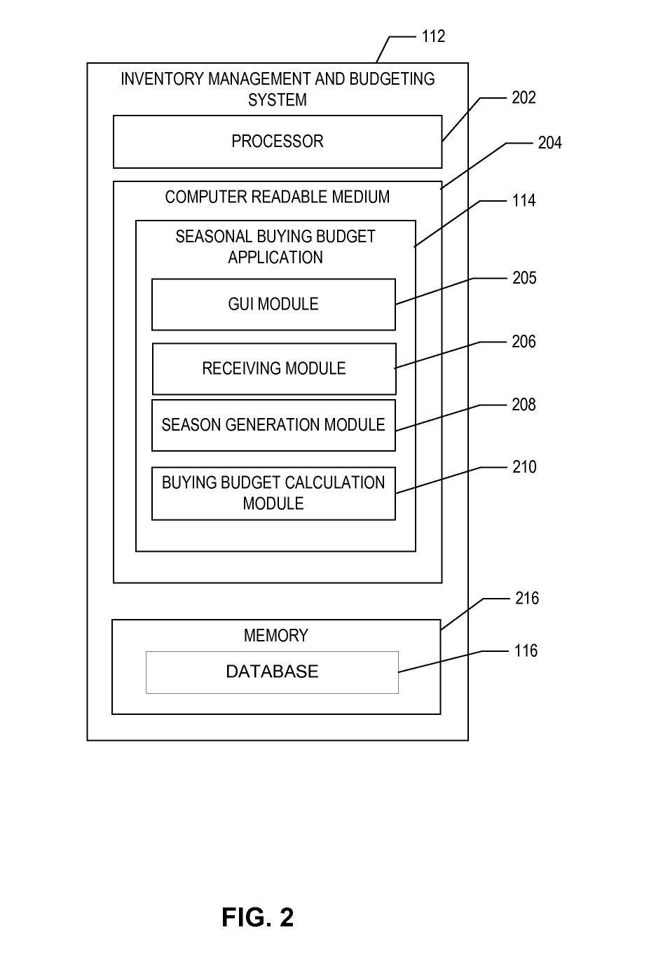

FIG. 2 is a block diagram that depicts the inventory management and budgeting system 112 that may be used to execute the seasonal buying budget application 114 (“SBBA”) executed on a processor 202 to calculate a buying budget. The processor 202 may include a memory 216 as well as other computing components.

The inventory management and budgeting system 112 may also include a memory 216 providing a database 116 to store revenue data, historical revenue data, inventory data, historical purchases data, and historical inventory data. The memory 216 may include volatile and/or non-volatile memory. According to one aspect, database 116 is a general repository of data including but not limited to revenue data, inventory data, and/or other data relating to generating a seasonal period and buying budget. The database 116 may include memory 216 and one or more processors or processing systems to receive, process, query and transmit communications and store and retrieve data. In another aspect, the database 116 may be a database server.

The inventory management and budgeting system 112 may include a computer readable media (“CRM”) 204 configured with the SBBA 114. The CRM 204 may include volatile media, nonvolatile media, removable media, non-removable media, and/or another available medium that can be accessed by the inventory management and budgeting system 112. By way of example and not limitation, the CRM 204 comprises computer storage media and communication media. Computer storage media includes memory, volatile media, nonvolatile media, removable media, and/or non-removable media implemented in a method or technology for storage of information, such as computer readable instructions, data structures, program modules, or other data, while communication media may embody computer readable instructions, data structures, program modules, data and an information delivery media or system.

According to one aspect of the disclosure, the SBBA 114 includes instructions or modules that are executable by the processor 202. Generally, program modules include routines, programs, objects, components, data structures, etc., that perform particular tasks or implement particular abstract data types. For example, in one embodiment, the SBBA 114 includes a GUI module 205, a receiving module 206, a season generation module 208, and a buying budget calculation module 210 that may be used to perform inventory management and calculate a seasonal buying budget as shall be discussed in greater detail below. It is contemplated that other modules may also be included.

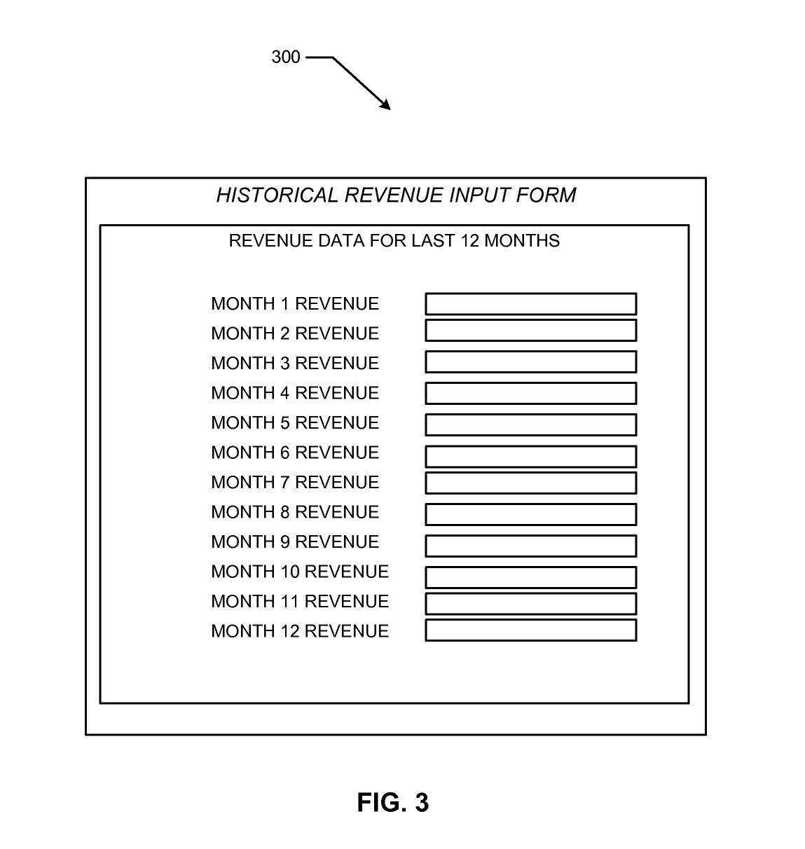

The GUI module 205 receives a seasonal period data entry request, such as historical revenue data entry request from computing devices 102-106 and/or the user interface 118. In response to the request, the GUI module 205 transmits a historical revenue data input form to display at computing devices 102-106 and/or the user interface 118. For purposes of illustration, an example historical revenue data input form is depicted in FIG. 3. It is contemplated that other types of seasonal period entry requests may be received by the GUI module 205, to which the GUI module 205 may respond by transmitting a corresponding input form.

The receiving module 206 receives a selection for a future budgeting period from a computing device (i.e. computing devices 102-106) and/or the point of sales system 108. The future budgeting period indicates the starting point and ending point for which a seasonal buying budget will be estimated. In one embodiment, the future budgeting period may be based on a calendar and extend 1-12 months. In another embodiment, the future budgeting period may follow a business' fiscal calendar.

According to another aspect, the receiving module 206 receives historical revenue data from the GUI module 205. For example, the receiving module 206 receives historical revenue data from the computing devices 102-106 and/or the point of sales system 108. In one embodiment, the historical revenue data is received as monthly revenue values for a maximum of a 12 month period. In another embodiment, the historical revenue data corresponds to the future budgeting period selection received by the receiving module 206 for a pervious time period. For example, the receiving module 206 receives a future budgeting period corresponding to a particular garden business calendar, in this case a three month period. The historical revenue data received by the receiving module 206 is historical revenue data for a 3 month period from a previous year or period, which corresponds to the 3 months of the current future budgeting period. As another example, assume the input module receives a future budgeting period corresponding to a particular garden business fiscal calendar from January 2012 to May of 2012, a four month period. The historical revenue data received by the input module corresponds to the garden business revenues from January 2011 to May of 2011, each month having a specific revenue value (e.g. February of 2011 revenue=$18,000; March of 2011 revenue=$22,000; April of 2011 revenue=$10,000; and May of 2011 revenue=$8,000).

According to one aspect, the receiving module 206 receives a revenue goal percentage. The revenue goal percentage represents the percentage increase or decrease in revenues expected in a particular seasonal period. For example, the receiving module 206 may receive a revenue goal percentage from the computing devices 102-106 and/or the point of sales system 108. Referring to the gardening example, if the gardening business expects a 4% increase in revenue for a first seasonal period.

According to another aspect, the receiving module 206 receives inventory data and/or historical inventory data. The historical inventory data may include inventory values at cost such as a beginning inventory for a particular seasonal period, a purchases value at cost for that seasonal period, and/or an ending inventory at cost for a seasonal period. A beginning inventory value refers to the inventory value at the beginning of the first month of that seasonal period generated by the season generation module 208. A Purchases value refers to a value representing the total purchases for a particular seasonal period generated by the season generation module 208. Finally, an ending inventory value equals the beginning inventory level for the first month of the next seasonal period.

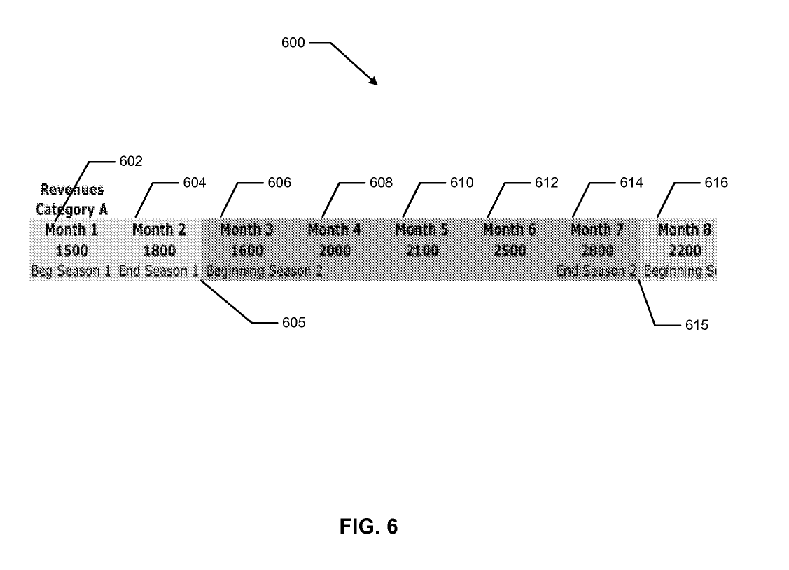

The season generation module 208 determines a seasonal period based on the historical revenue data received by the receiving module 206. According to one aspect, the season generation module 208 determines a seasonal period by analyzing the historical revenue data to identify a maximum revenue month and a seasonal period ending month subsequent to the maximum revenue month. The maximum revenue month and the seasonal period ending month is used to define a transition between one seasonal period and the next seasonal period. As an example, referring to FIG. 6, assume that historical revenue data received by the receiving module 206 for a gardening business G included: Month 1 602 revenue of $1500; Month 2 604 revenue of $1800; and Month 3 606 revenue of $1600. The season generation module analyzes the revenue values for Month 1 602, Month 2 604, and Month 3 606 to identify a maximum at Month 2 606, with revenues of $1800. The maximum revenue month and subsequent end of season month may be identified through the greatest deviation from the maximum month or through user knowledge from past management of the category department. The season generation module 208 then identifies a seasonal period ending month as the month subsequent to the maximum month, in this example Month 3 606. Alternatively, the season generation module 208 may determine a greatest declining deviation (decrease) in revenue before the revenue start rising again when compared to the maximum month revenues, and identify the month associated with such revenues as the seasonal ending period month. Finally, the season generation module 208 defines a transition 605 between Month 2 604 and Month 3 606, that defines the beginning of one seasonal period and the next seasonal period. In the current example, the first seasonal period is determined to extend from Month 1 602 to Month 2 604 and the beginning of the next season begins at Month 3 606. To generate a second seasonal period, the seasonal generation module 208 analyzes historical revenue data starting with Month 3 604 (the beginning of the next seasonal period) through Month 8 616 to identify the next maximum month. In this example, the maximum month is Month 7 214 with revenues of $2800. Subsequently, the season generation module 208 identifies a seasonal period ending month as Month 8 616. The season generation module 208 defines a transition 605 between Month 7 614 and Month 8 616, that defines the beginning of the second seasonal period and the next seasonal period. The second seasonal period is determined to extend from Month 3 606 to Month 7 614 and the beginning of the next season begins at Month 8 616. It is contemplated that the season generation module 208 may generate multiple, a plurality, or more than one or two seasonal periods.

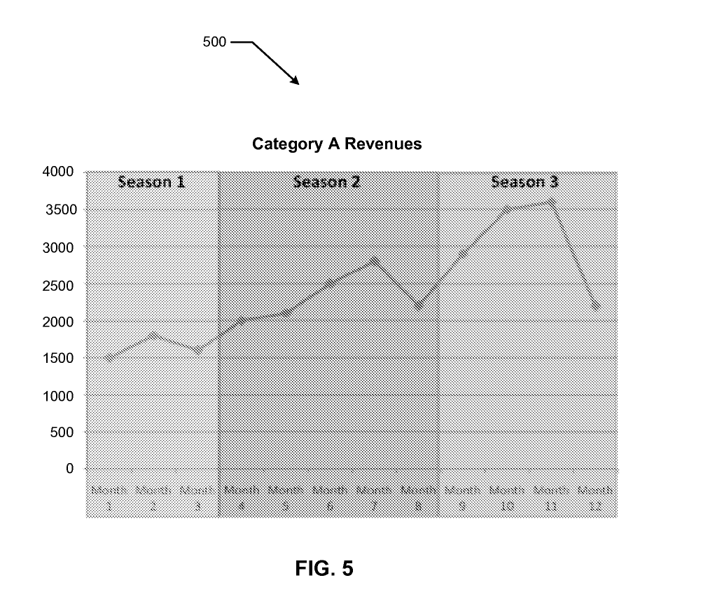

Referring back to the GUI module 205, the GUI module 205 generates a graphical user interface to display the seasonal periods generated by the season generation module 208. The graphical user interface may include a modification tool, such as a slidebar, radio button, text form, and/or any other type of graphical input for entering a modification. In one aspect, the modification tool may receive input that redefines the seasonal period generated by the season generation module 208 based on one or more customization criteria. Customization criteria may include personal management experience of the category, department, and/or particular product, etc. For example, if a seasonal period were generated by the season generation module 208 that extended 5 months, the modification tool may receive input shortening the seasonal period to 3 months. Alternatively, the user may use the modification tool to accept the seasonal period generated by the season generation module 208. FIG. 5 is an illustrative example of how seasonal periods may be displayed by the season generation module 208 via the graphical user interface.

The buying budget calculation module 210 calculates a buying budget based on inventory data received by the receiving module 206 and the corresponding seasonal period generated by the season generation module 208. According to one aspect, in order to calculate the buying budget the buying budget calculation module 210 may perform multiple calculations using the historical inventory data and historical revenue data and any other data or value received by the receiving module 206.

According to one aspect, the buying budget calculation module 210 may calculate the cost of goods sold for each seasonal period generated by the season generation module 208. The cost of goods sold may be calculated using the equation:

Cost of Goods Sold=Beginning Inventory+Purchases−Ending Inventory.

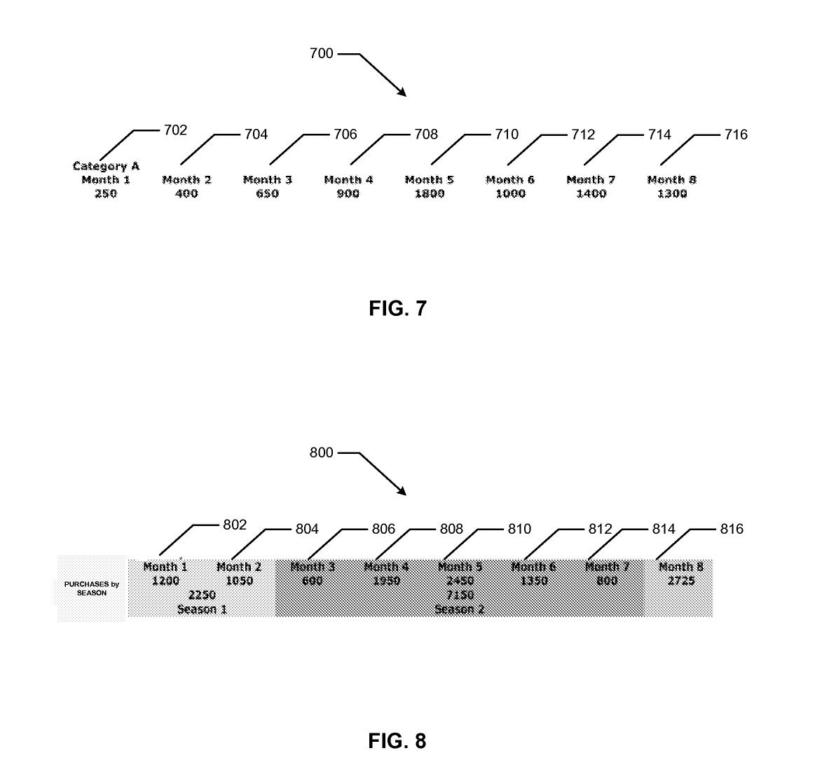

For example, FIG. 7 depicts inventory values for eight months corresponding to the eight months depicted in FIG. 6 that define two seasonal periods. Each month illustrated in FIG. 7 corresponds to a month depicted in FIG. 6. Thus, Month 1 702 corresponds to Month 1 602, Month 2 704 corresponds to Month 2 604, etc. FIG. 8 depicts a purchases value for eight different months. Again, each month corresponds to the eight months depicted in FIG. 6. Accordingly, the cost of goods sold for the first seasonal period=$250 (Beginning Inventory)+$2250 (Purchases)−$650 (Ending inventory of first seasonal period/beginning inventory of Month 8)=$1850.

According to another aspect, the buying budget calculation module 210 may calculate a Cost of Goods Sold Percentage for each seasonal period generated by the generation module 208. For example, the cost of goods sold percentage may be calculated using the equation:

Cost of Goods Sold Percentage=Cost of Goods Sold/Revenues

wherein “revenues” is equal to the total revenues for a seasonal period. Referring back to FIGS. 6 and 7, the total revenues for the first seasonal period is $3300 (Month 1 602 revenue of $1500+Month 2 604 revenue of $1800). Thus, the cost of goods sold percentage for the first seasonal period=1850/3300=0.5606, or 56%

According to yet another aspect, the buying budget calculation module 210 calculates a resultant margin percentage for each seasonal period generated by the generation module 208. For example, the resultant margin percentage may be calculated using the equation:

Margin Percentage=(Revenues−Cost of Goods Sold)/Revenues

Referring again to FIGS. 6 and 7 and the related calculations above, the margin percentage for the first seasonal period=($3300−$1850)/($3300)=0.4394, or 44%. Alternatively, the margin percentage may be calculated using the equation:

Margin Percentage=100%−Cost of Goods Sold Percentage

According to one aspect, the buying budget calculation module 210 uses the revenue goal percentage received by the receiving module 206 and the cost of goods sold percentage to calculate a goal cost of goods sold value using the equation:

Goal Cost of Goods Sold=Cost of Goods Sold Percentage−desired change in cost of goods sold.

The desired change in cost of goods sold may be a percentage and may represent a desired increase in cost of goods sold and/or a desired decrease in cost of goods sold.

According to one aspect, the buying budget calculation module 210 may use the revenue goal percentage received by the receiving module 206 and the total revenue for a seasonal period to determine the desired seasonal period revenue total. For example, the desired seasonal period revenue total may be calculated using the equation:

Seasonal Period Revenue Goal=seasonal period revenues+(revenue goal percentage*seasonal period revenues)

Thus, if the revenue goal percentage increase were 2% and the seasonal period revenues were 3300, the Seasonal Period Revenue Total=3300+(0.02*3300)=3366.

The buying budget calculation module 210 uses the goal cost of goods sold value to calculate a budgeted inventory needed at cost value per seasonal period (“INC”). For example, the INC may be calculated using the equation:

INC=Goal Cost of Goods Sold*Seasonal Period Revenue Goal

For example, using a goal cost of goods sold of 32% and the total revenue for the first seasonal period of $3366, INC=0.32*($3366)=1078.

The buying budget calculation module 210 uses the INC, an inventory on hand at beginning of period at cost value, and a seasonal purchases at cost value to calculate a buying budget (“BB”). The Inventory on Hand at Cost is the category and/or department value of inventory on hand at cost at the beginning of the seasonal period. The seasonal purchases at cost is defined as those purchases made for or during the season. For example, the buying budget may be calculated using the equation:

BB=INC−Inventory on Hand at Beginning of Period at Cost−Purchases at Cost

If the BB is a positive balance, then the business retailer may need to purchase inventory with the remaining positive balance in order to meet the revenue goals for the seasonal period. If the BB is a negative balance, then the business retailer may be over-inventoried and should take actions, which may include discounting or other means of inventory reduction during the season to reduce the inventory on hand.

In some instances, users may want to modify the values calculated by the buying budget 210 based on confounding factors and elements that arise during a season. Thus, according to another aspect, the buying budget module 210 may generate a graphical user-interface comprising input forms to receive modified revenue data and inventory data as well as a modified version of any of the values calculated by the buying budget module 210. For example, the a graphical user-interface may be generated by the buying budget module 210 that allows a user to input a modified Goal Cost of Goods Sold value using the various input fields/forms. It is contemplated that any value calculated by the buying budget 210 may be modified through a graphical user interface.

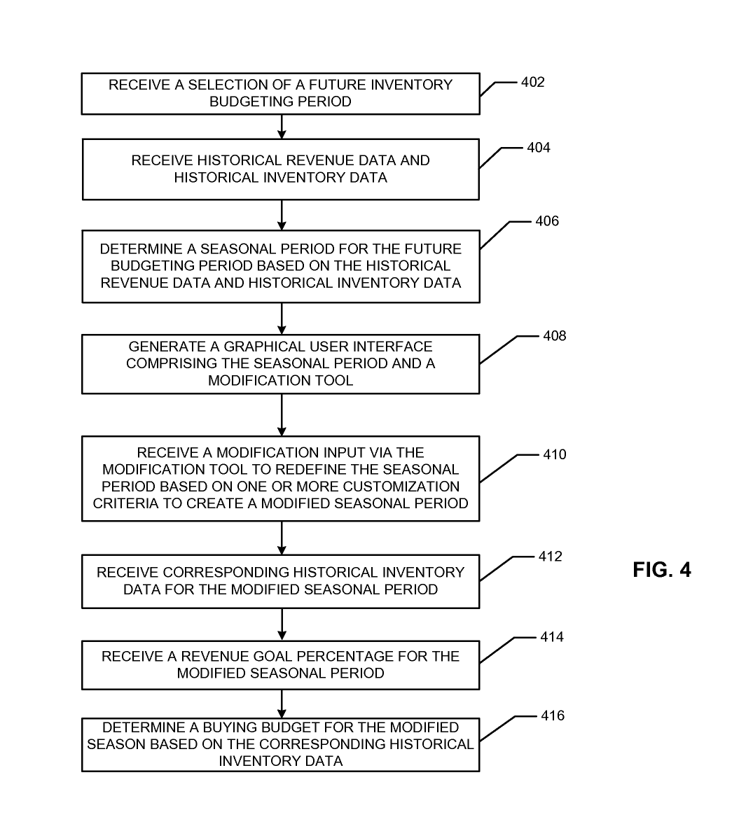

FIG. 4 illustrates an example workflow for calculating a seasonal buying budget. At block 402, a selection of a future inventory budgeting period is received. Historical revenue data and historical inventory data is then received at block 404. At block 406, a seasonal period for the future inventory budgeting period is determined based on the historical revenue data and the historical inventory data. At block 408 graphical user interface may include the seasonal period and a modification tool to modify the seasonal period and create a modified seasonal period is generated. At block 410, a modification input is entered via the modification tool, wherein the modification input redefines the seasonal period based on one or more customization criteria. At block 412, corresponding historical inventory data for the at least one modified seasonal period is received. At block 414, a revenue goal percentage for the modified seasonal period is received. At block 416, a buying budget for the modified seasonal period is then calculated based on the corresponding historical inventory data.

Thus, inventory management and budgeting system 112 calculates a seasonal buying budget based on historical revenue data and historical inventory data. In particular, a seasonal buying budget may be calculated for a particular season that considers the anticipated Margin/Cost of goods sold, the mount of inventory on hand, and changing revenue goals forecasted for future months.

The inventory management and budgeting system 102 may include example systems, methods, techniques, instruction sequences, and/or computer program products that embody techniques of the present disclosure. However, it is understood that the described disclosure may be practiced without these specific details.

In the present disclosure, the methods for determining a seasonal buying budget disclosed herein may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

1. A method for inventory management and budgeting comprising:
receiving, at a processor, a selection of a future inventory budgeting period;
receiving, at the processor, historical revenue data and historical inventory data;
determining, at the processor, at least one seasonal period based on the historical revenue data and the historical inventory data for the future inventory budgeting period;
generating, at the processor, a graphical user interface for display comprising the at least one seasonal period and a modification tool to modify the at least one seasonal period;
receiving, at the processor, a modification input via the modification tool of the graphical user interface, the modification input redefining the at least one seasonal period to create at least one modified seasonal period based on one or more customization criteria;
receiving, at the processor, corresponding historical inventory data for the at least one modified seasonal period;
receiving, at the processor, a revenue goal percentage for the at least one modified seasonal period;
determining, at the processor, a buying budget for the at least one modified seasonal period based on the corresponding historical inventory data and the revenue goal percentage;
determining, at the processor, a buying budget for the at least one seasonal period based on the historical revenue data, the historical inventory data, and the revenue goal percentage; and
displaying, at the processor, the buying budget on the graphical user interface.

2. The method of claim 1, wherein the historical revenue data and the historical inventory data is received monthly over a 12 month period.

3. The method of claim 1, wherein the at least one seasonal period comprises a first seasonal period and a second seasonal period, the method further comprising:
comparing historical revenue data between a plurality of consecutive months to identify a maximum revenue month;
identifying a seasonal period ending month; and
defining a transition between a first seasonal period and a second seasonal period based on the seasonal period ending month.

4. The method of claim 3, wherein the seasonal period ending month is the month with the greatest declining deviation in revenue from the revenue of the maximum revenue month.

5. The method of claim 3, wherein the modification input redefines the number of months that the at least one seasonal period extends.

6. The method of claim 1, wherein the future inventory budgeting period is 12 months and wherein the at least one seasonal period is defined as extending at least one month of the 12 months of the future inventory budgeting period.

7. The method of claim 1, wherein the modification tool is a slidebar.

8. The method of claim 1, wherein the corresponding historical inventory data comprises:
a beginning inventory value indicating an inventory level at the beginning of the at least one modified seasonal period;
a purchases value indicating the purchases made during the at least one modified seasonal period; and
an ending inventory value indicating the inventory level at the end of the at least one modified seasonal period.

9. The method of claim 1, wherein determining the buying budget for the at least one modified seasonal period comprises:
calculating, at the processor, a cost of goods sold value based on the beginning inventory value, the purchases value, and the ending inventory value;
calculating, at the processor, a cost of goods sold percentage based on the cost of goods sold value and a total revenues value for the at least one modified seasonal period;
calculating, at the processor, a goal cost of goods sold based on the cost of goods sold percentage and a desired change in cost of goods sold percentage;
calculating, at the processor, a seasonal period revenue goal based on the revenue data and the monthly revenue goal percentage;
calculating, at the processor, an inventory needed at cost value for the at least one modified seasonal period based on the monthly revenue goal percentage and the seasonal period revenue goal; and
calculating a buying budget for the at least one modified seasonal period based on the inventory needed at cost value, an inventory at cost on hand value, and a monthly purchases at cost value.

10. The method of claim 1, further comprising generating for display a user interface to receive a modified monthly goal percentage value to calculate a modified buying budget.

11. A system for inventory management and buyer budgeting comprising:
at least one processor;
a memory in operable communication with the at least one processor; and
a seasonal buying budget application comprising modules executable by the processor, the modules comprising:
a GUI module to:
generate a graphical user interface for display comprising at least one seasonal period and the modification tool to modify the at least one seasonal period to create the at least one modified seasonal period; and
receive a modification input via a modification tool, the modification redefining the at least one seasonal period based on one or more customization criteria;
a receiving module to:
receive a selection of a future inventory budgeting period;
receive historical revenue data and historical inventory data;
receive corresponding historical inventory data for at least one modified season; and
receive a revenue goal percentage for the at least one modified season;
a season generation module to:
determine the at least one seasonal period based on the historical revenue data and the historical inventory data for the future inventory budgeting period; and
a buying budget module to determine a buying budget for the at least one modified seasonal period based on the corresponding historical inventory data and the revenue goal percentage.

12. The system of claim 11, wherein the historical revenue data and the historical inventory data is received monthly over a 12 month period.

13. The system of claim 11, wherein the season generation module determines the at least one seasonal period by:
analyzing, at the processor, the historical revenue data for each month of the 12 month period to identify a decrease revenue value when compared to a first month revenue value of a first month;
identifying, at the processor, a second month corresponding to the decrease revenue value; and
defining, at the processor, the at least one seasonal period to extend from the first month to the second month.

14. The system of claim 11, wherein the modification input redefines the number of months that the at least one seasonal period extends.

15. The system of claim 11, wherein the future inventory budgeting period is 12 months and wherein the at least one seasonal period is defined as extending at least one month of the 12 months of the future inventory budgeting period.

16. The system of claim 11, wherein the modification tool is a slidebar.

17. The system of claim 11, wherein the corresponding historical data comprises:
a beginning inventory value indicating an inventory level at the beginning of the at least one modified seasonal period,
a purchases value indicating the purchases made during the at least one modified seasonal period, and
an ending inventory value indicating the inventory level at the end of the at least one modified seasonal period.

18. The system of claim 11, wherein the budget buying module determines the buying budget for the at least one modified seasonal period by:
calculating, at the processor, a cost of goods sold value based on the beginning inventory value, the purchases value, and the ending inventory value;
calculating, at the processor, a cost of goods sold percentage based on the cost of goods sold value and a total revenues value for the at least one modified seasonal period;
calculating, at the processor, a goal cost of goods sold based on the cost of goods sold percentage and a desired change in cost of goods sold percentage;
calculating, at the processor, a seasonal period revenue goal based on the revenue data and the monthly revenue goal percentage;
calculating, at the processor, an inventory needed at cost value for the at least one modified seasonal period based on the monthly revenue goal percentage and the seasonal period revenue goal; and
calculating a buying budget for the at least one modified seasonal period based on the inventory needed at cost value, an inventory at cost on hand value, and a monthly purchases at cost value.

19. A computer-readable medium encoded with a seasonal buying budget application comprising modules executable by a processor, the modules comprising:
a GUI module to:
generate a graphical user interface for display comprising at least one seasonal period and the modification tool to modify the at least one seasonal period to create the at least one modified seasonal period; and
receive a modification input via a modification tool of the graphical user interface, the modification redefining the at least one seasonal period based on one or more customization criteria; and
display a buying budget on the graphical user interface.
a receiving module to:
receive a selection of a future inventory budgeting period;
receive historical revenue data and historical inventory data;
receive corresponding historical inventory data for at least one modified season; and
receive a revenue goal percentage for the at least one modified season;
a season generation module to:
determine the at least one seasonal period based on the historical revenue data and the historical inventory data for the future inventory budgeting period; and
a buying budget module to determine the buying budget for the at least one modified seasonal period based on the corresponding historical inventory data and the revenue goal percentage.

20. The computer-readable medium of claim 19, wherein the season generation module determines the at least one seasonal period by:
analyzing, at the processor, the historical revenue data for each month of the 12 month period to identify a decrease revenue value when compared to a first month revenue value of a first month;
identifying, at the processor, a second month corresponding to the decrease revenue value; and
defining, at the processor, the at least one seasonal period to extend from the first month to the second month.

21. The computer-readable medium of claim 19, wherein the corresponding historical data comprises:
a beginning inventory value indicating an inventory level at the beginning of the at least one modified seasonal period,
a purchases value indicating the purchases made during the at least one modified seasonal period, and
an ending inventory value indicating the inventory level at the end of the at least one modified seasonal period.

22. The computer-readable medium of claim 19, wherein the budget buying module determines the buying budget for the at least one modified seasonal period by:
calculating a cost of goods sold value based on the beginning inventory value, the purchases value, and the ending inventory value;
calculating a cost of goods sold percentage based on the cost of goods sold value and a total revenues value for the at least one modified seasonal period;
calculating a goal cost of goods sold based on the cost of goods sold percentage and a desired change in cost of goods sold percentage;
calculating an inventory needed at cost value for the at least one modified seasonal period based on the monthly revenue goal percentage and the goal cost of goods sold percentage; and
calculating a buying budget for the at least one modified seasonal period based on the inventory needed at cost value, an inventory at cost on hand value, and a monthly purchases at cost value.
